(19) United States
(12) Patent Application Publication
(10) Pub. No.: US 2017/0373921 A1
(43) Pub. Date: Dec. 28, 2017

(54) METHOD AND APPARATUS FOR SNMP SET OPERATIONS

(71) Applicant: THOMSON LICENSING, Issy les Moulineaux (FR)

(72) Inventors: Tao ZHOU, Hangzhou (CN); Ming PAN, Hangzhou (CN); Ye BAO, Hangzhou (CN); Hailong YE, Hangzhou (CN)

(21) Appl. No.: 15/539,678

(22) PCT Filed: Dec. 25, 2014
(86) PCT No.: PCT/CN2014/095000

§ 371 Date: Jun. 24, 2017

(51) Int. Cl. H04L 12/24

(52) U.S. Cl. CPC H04L 41/0213; H04L 41/0813; H04L 41/0889

(57) ABSTRACT

A method and an apparatus for communication between a first network device and second network device are suggested. The method comprises, at the level of the first network device: receiving, from the second network device, one or more requests for SNMP Set operation; caching the one or more requests; and upon a determined time period being reached, processing the cached one or more requests. A cache mechanism is suggested so that an SNMP agent can cache the requests for SNMP Set operation for a time period and process these requests in batch.

### TECHNICAL FIELD

The present disclosure generally relates to data management technologies. In particular, the present disclosure relates to a method and an apparatus for SNMP Set operations.

### BACKGROUND

Simple Network Management Protocol (SNMP) is an Internet-standard protocol for managing devices on IP networks. It is a component of the Internet Protocol Suite as defined by the IETF (Internet Engineering Task Force) and has been widely used in network management systems (NMSs).

The SNMP protocol supports two basic managed objects which are Scalar and Tabular, and four basic operations which are Get, GetNext, Getbulk and Set. AN SNMP Scalar object defines a single object instance. An SNMP Tablular object defines multiple related object instances that are grouped in an MIB (Management Information Base) table, which is a database table and can hold many rows of data therein. AN SNMP Get operation is an NMS-to-agent request to retrieve the value of a variable or a list of variables, and an agent in an NE (Network Element) will give SNMP Response to the NMS for the variables requested in SNMP Get PDU (protocol data unit). AN SNMP GetNext operation is similar to Get operation. The difference is that the agent will return a response with variable binding for the lexicographically next variable in the MIB. AN SNMP GetBulk operation can specify max-repetitions value and will return multiple rows of data max-repetitions indices.

FIG. 1 is an exemplary diagram showing the SNMP Set operation between an SNMP client and an SNMP agent. In the example of FIG. 1, the SNMP client can be a NMS or other third party software. The SNMP agent is an SNMP enabled device, which can be an NE in the network.

When an SNMP client sends a plurality of request for SNMP Set operation to the SNMP agent, the SNMP agent needs to handle these SNMP Set operations one by one. FIG. 1 shows an example that the SNMP client sends sequentially three requests for SNMP Set operation to the SNMP agent. As shown in FIG. 1, for the first request, the following process is carried out:

101) The SNMP client sends an SNMP Set request to the SNMP agent;

111) The SNMP agent sends the request to the sub-system for processing;

112) The SNMP agent receives a response from the sub-system when the processing is finished; and

113) The SNMP agent sends a response to the SNMP client.

As shown in FIG. 1, for SNMP Set request in step 102 and SNMP Set request in step 103, the similar process will be carried out, which includes steps of 102, 121, 122, 123 and 103, 131, 132, 133. No detailed description will be given.

Thus it can be seen, in the case that there are a plurality of requests for SNMP Set operation, it may take a long time for the SNMP agent to finish the processing of these requests, especially when the processing is complicated to an internal sub-system or an the sub-system is on an external device (additional time may be needed for the message exchanges between the SNMP agent and the external device). In many cases, the sub-system of the SNMP agent is an internal embedded system, such as a sub-card in an NE. In such case, the sub-system normally does not have a powerful computational capability due to hardware limitations. Therefore, the above-described process is time consuming, which may need seconds to tens of seconds in practice.

### SUMMARY

According to a first aspect of the disclosure, a method for communication between a first network device and second network device is provided. The method comprises, at the level of the first network device: receiving, from the second network device, one or more requests for SNMP Set operation; caching the one or more requests; and upon a determined time period being reached, processing the cached one or more requests.

In an embodiment, the method further comprises sending a response to the second network device upon receipt of the request.

In an embodiment, the determined time period is set to start from a time when the first one of the one or more requests is cached.

In an embodiment, the processing comprises sending the cached one or more requests to a processing device for processing the requests.

In an embodiment, the method further comprises sending a message to the second network device indicating the status of the processing of the one or more cached requests.

According to a second aspect of the disclosure, a method for communication between a first network device and second network device is provided. The method comprises, at the level of the second network device: transmitting, to the first network device, a request for SNMP Set operation; and upon receipt of a response from the first network device indicating the receipt of the request, transmitting another request for SNMP Set operation to the first network device.

In an embodiment, the method further comprises receiving, from the first network device, a message indicating the status of the processing of the request.

According to a third aspect of the disclosure, an apparatus is provided. The apparatus comprises: an interface configured to exchange packets with an external device; a memory configured to store data required for operation of the apparatus; and a processor configured to: receive, from the external device, one or more requests for SNMP Set operation; cache the one or more requests in the memory; and upon a determined time period being reached, process the cached one or more requests.

In an embodiment, the apparatus is a network device functioning as an SNMP agent.

According to a fourth aspect of the disclosure, an apparatus is provided. The apparatus comprises: an interface configured to exchange packets with an external device; a memory configured to store data required for operation of the apparatus; and a processor configured to: transmit, to the external device, a request for SNMP Set operation; and upon receipt of a response from the external device indicating the receipt of the request, transmit another request for SNMP Set operation to the external device.

In an embodiment, the apparatus is a server functioning as an SNMP agent.

According to a fifth aspect of the disclosure, there is provided a computer program product downloadable from a communication network and/or recorded on a medium readable by computer and/or executable by a processor, comprising program code instructions for implementing the steps of a method according to the first and second aspects of the disclosure.

According to a sixth aspect of the present disclosure, there is provided non-transitory computer-readable medium comprising a computer program product recorded thereon and capable of being run by a processor, including program code instructions for implementing the steps of a method according to the first and second aspects of the disclosure.

It is to be understood that more aspects and advantages of the disclosure will be found in the following detailed description of the present disclosure.

### BRIEF DESCRIPTION OF THE DRAWINGS

The accompanying drawings are included to provide further understanding of the embodiments of the disclosure together with the description which serves to explain the principle of the embodiments. The disclosure is not limited to the embodiments.

In the drawings:

FIG. 1 is an exemplary diagram showing the SNMP Set operation between an SNMP client and an SNMP agent;

FIG. 2 is an exemplary diagram showing a method for SNMP Set operation between an SNMP client and an SNMP agent according to an embodiment of the disclosure;

FIG. 3 is a flow chart showing the method for SNMP Set operation between an SNMP client and an SNMP agent according to an embodiment of the disclosure;

FIG. 4 is a block diagram showing an SNMP agent according to an embodiment of the disclosure; and

FIG. 5 is a block diagram showing an SNMP client according to an embodiment of the disclosure.

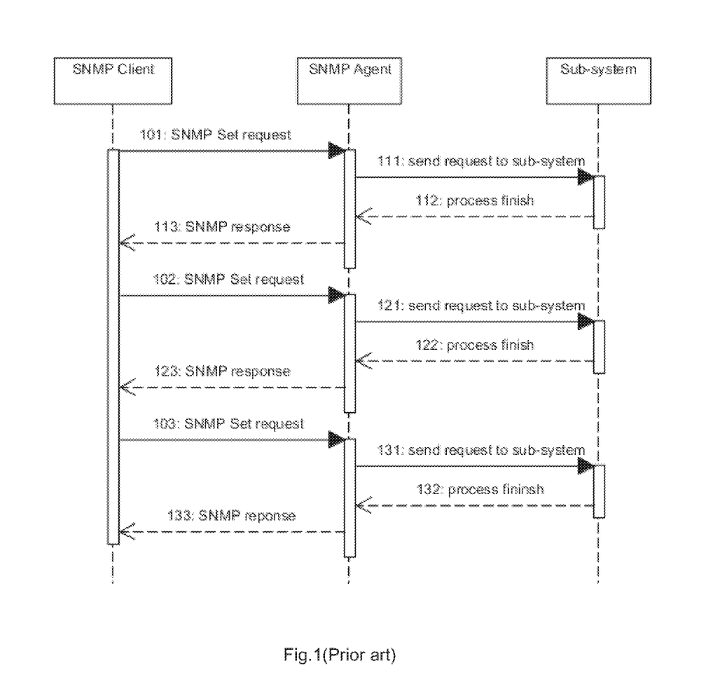

### DETAILED DESCRIPTION

An embodiment of the present disclosure will now be described in detail in conjunction with the drawings. In the following description, some detailed descriptions of known functions and configurations may be omitted for conciseness.

A telecommunications network generally comprises one or more network devices (NEs) and management software (NMS). The NEs and the NMS can communicate with the SNMP protocol. For example, in some context, the NE can be a mini-CMTS (mini cable modem terminal system) or an OLT (Optical Line Terminal) device. In this case, the NMS contains the software, on a server, for managing all these mini-CMTS or OLT devices remotely using the SNMP protocol.

The NMS can act as an SNMP client which will get and set the configuration of an NE in the network. In this case, the NE will act as an SNMP agent, which can receive requests from the NMS, carry out corresponding internal processing and give a response to the NMS. In an example, the NE can be a layer-two mini-CMTS device, which acts as a bridge to connect a cable modem and upper layer switch/OLT network together. The mini-CMTS device can comprise two parts, one is a host CPU acting as the NE and the other a DOCSIS (Data-Over-Cable Service Interface Specifications) module as the sub-system for processing data and request from the NMS, as described in the background section. The host CPU can implement an SNMP agent to direct communicate with the NMS. The NMS can send a request for SNMP Set operation to change the configuration of the NE. If the configuration is for the host CPU side, the host CPU will process these requests, and give a response to the NMS. If the configuration is for the DOCSIS part, the host CPU will send a request to the DOCSIS module which will process the configuration.

The disclosure proposes to define a cache mechanism, for an SNMP agent to cache the requests for SNMP Set operation for a time period so that these requests can be processed in batch.

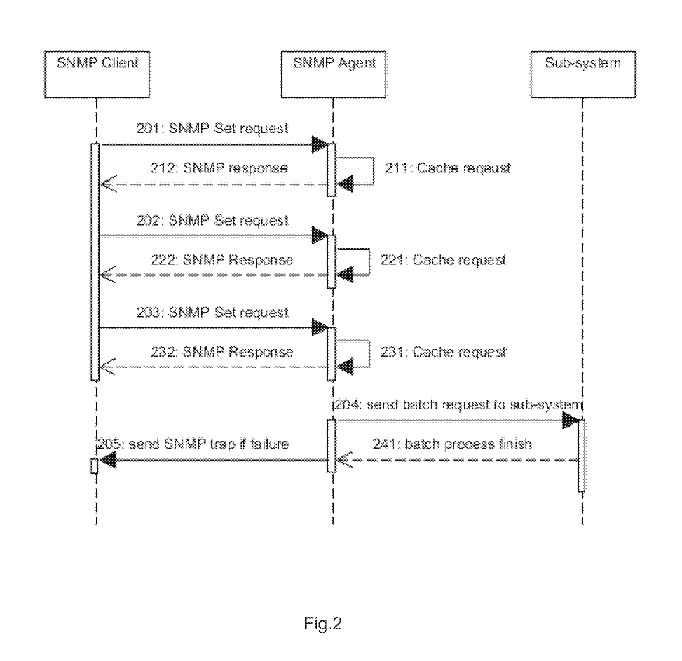

FIG. 2 is an exemplary diagram showing a method for SNMP Set operation between an SNMP client and an SNMP agent according to an embodiment of the disclosure.

As shown in FIG. 2, the process comprises a step 201 wherein the SNMP client sends a first request for SNMP Set operation to the SNMP agent. In the step 201, the SNMP client can construct a PDU encapsulating the variables of the request for SNMP Set operation and send the constructed PDU to the SNMP agent.

The process further comprises a step 211 wherein upon receipt of the first request, the SNMP agent caches the first request in a memory for a time period.

In the above step 211, the time period can be preset, for example, as 500 ms. The time period can start from the time when the first request is cached. The memory can be the internal memory of the SNMP agent.

Then at the next step 212, the SNMP agent sends an SNMP response to the SNMP agent. Messages defined in the SNMP protocol can be used in this step. For example, the SNMP response sent by the SNMP agent can be a standard SNMP successful response with value noError(0) for error-status field in PDU. No further details will be given.

As shown in FIG. 2, the process can further comprise the following steps of:

202) upon receipt of the SNMP response by the SNMP client, the SNMP client sends a second request for SNMP Set operation to the SNMP agent; and

221) the SNMP agent caches the second request in the memory within the above time period, and;

222) the SNMP agent sends an SNMP response to the SNMP agent upon receipt of the second request.

Similarly, for an additional request, the process can further comprise the following steps of:

203) upon receipt of the SNMP response by the SNMP client, the SNMP client sends a third request for SNMP Set operation to the SNMP agent; and

231) the SNMP agent caches the third request in the memory within the above time period, and

232) the SNMP agent sends an SNMP response to the SNMP agent upon receipt of the third request.

Further additional requests will subject to the similar process and be cached if the time period does not expire.

Then the process proceeds to a step 204 wherein when the time period expires, the SNMP client sends the cached requests for SNMP Set operation in batch to the a sub-system for processing the requests. Briefly, the SNMP client will parse the variables in the requests and send the needed variables to the sub-system for processing the requests.

According to the embodiment of the disclosure, the sub-system processes all the requests together. Since the requests for SNMP Set operation are sent in batch to the sub-system which will process them together, there is no need for the sub-system to prepare the context for a single request each time when receiving a request. Therefore, a reducing of processing time is expected.

In this example shown in FIG. 2, the SNMP client sends the cached requests to the sub-system for processing. The sub-system can be an internal or external device or unit of the SNMP client. But it can be appreciated that the request can be processed by the SNMP client itself. For example, in the mini-CMTS device described above, a host CPU and a DOCSIS module are contained. The host CPU can implement an SNMP agent and at the same time process the request from a NMS for the configuration of the host CPU. Then in this embodiment, if the request of SNMP Set operation is for the host CPU, the SNMP agent (the host CPU in this case) will process the cached requests by itself when the time period expires. But if the requests are for the configuration of the DOCSIS part, the SNMP agent will send a request to an internal unit, the DOCSIS module, for processing the cached requests.

The process can further comprise a step 241 wherein the SNMP agent sends a standard SNMP response to the SNMP client to notify the SNMP client that the request is successfully processed. For this purpose, the SNMP agent can send an internal RPC (Remote Procedure Call) call to the sub-system and wait for the response from the sub-system. Upon receipt of a response, the SNMP agent will parse the response to get the required value. Then the SNMP agent will construct an SNMP Response PDU and send it to the SNMP client.

It can be appreciated that the SNMP agent can chose not to notify the SNMP client the success of the processing.

The process can further comprise a step 205 wherein the SNMP agent sends a message to the SNMP client to notify the SNMP client that the request is not processed.

AN SNMP Trap can be used in the above step 205 for the SNMP agent to notify the details of the failure to the SNMP client. The SNMP Trap is initiated by the SNMP agent to actively notify SNMP client of something wrong happened. A sample SNMP Trap instance is defined as below for the failure of the request for SNMP Set operation.

```
cacheBulkSetNotificationTrap NOTIFICATION-TYPE
    OBJECTS { cacheBulkSetErrorCode,
        cacheBulkSetObjects }
    STATUS current
    DESCRIPTION
        “This trap/event indicates that the result (in case error) for
        a cache bulk set operation.
        The following variables are returned:
          cacheBulkSetErrorCode - detailed error code for the failure,
          cacheBulkSetObjects - cache bulk set object value,
          ”
    ::= { cacheBulkSetNotificationTrap s1 }
```

It can be appreciated that the SNMP agent can select not to notify the SNMP client that the request is not processed.

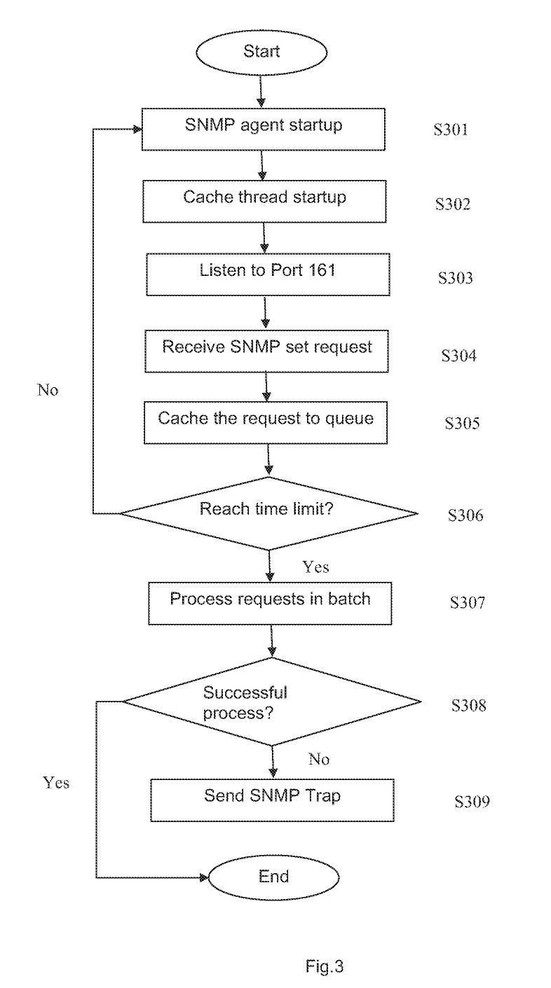

FIG. 3 is a flow chart showing the method for SNMP Set operation between an SNMP client and SNMP agent according to an embodiment of the disclosure.

As shown in FIG. 3, at step S301, an SNMP agent starts up. The SNMP agent can operate on an NE which in one example is a mini-CMTS device described above.

At step S302, the SNMP agent creates a cache thread or task. The way to create a thread depends on the OS (Operation System) of the SNMP agent. For a Linux system, a pthread_create( ) system call can be used to create a thread. For vxWorks system, a taskspawn( ) system call can be used to create a task. The main responsibility of the new thread or task is to maintain timer and queue for holding the cached variable-bindings. When the time of the timer is up, the current variable-bindings in the cache will be constructed into a single parameter for RPC call to the sub-system.

At step S303, the SNMP agent creates a socket and listens to the port 161 in the NE for incoming request for SNMP Set operation from an SNMP client. The port 161 is the official port number for SNMP communication defined in RFC 1157. The SNMP client can be a NMS or a 3rd party SNMP client.

If the SNMP agent receives a request for SNMP Set operation at step S304, at step S305, it will cache the variables encapsulated in a request PDU and put it in a queue.

At step S306, the SNMP agent determines whether a time limit is reached. The time limit can be determined from a cache timer which starts from the time when the first request is cached. In one example, the time limit can be set as 500 ms.

If the determination result of step S306 is “No”, the process will go to step S303 to and listens to the port 161 in the NE for incoming request for SNMP Set operation from an SNMP client.

If the determination result of step S306 is “Yes”, the process will go to step S307 for the SNMP agent to send all the cached requests in batch to a sub-system for processing the requests. As described above, the sub-system for processing the request for SNMP Set operation can be internal or external to the SNMP agent depending on the context of the application. The SNMP agent can send all the cached requests by a RPC (Remote Procedure Call) call or other standard network protocol such as SNMP. The RPC call can be a proprietary network protocol, based on UDP or TCP.

At next step S308, the SNMP agent will wait for the execution result for the request processing from the sub-system. If the request is processed successfully, the process will stop. If the request is not processed successfully, at step S309, the SNMP agent will send an SNMP Trap to the SNMP client to notify the details about the failure.

The embodiments of the disclosure are described with reference to a mini-CMTS network. However, it can be appreciated that the disclosure can also apply to other context of communications with SNMP protocol.

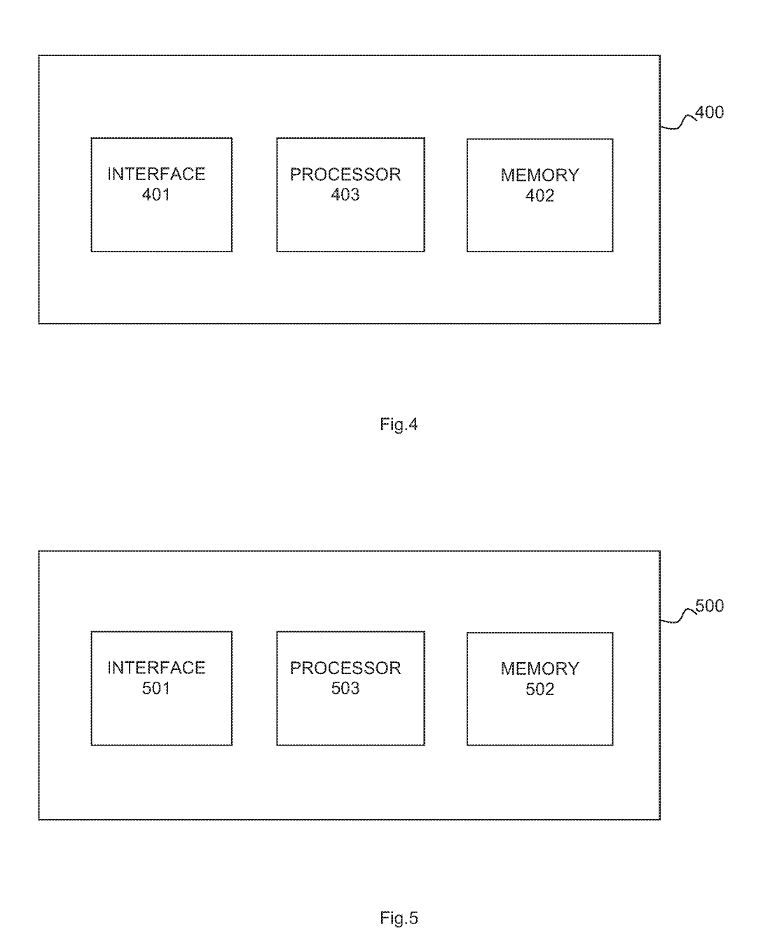

FIG. 4 is a block diagram showing an SNMP agent according to an embodiment of the disclosure.

As shown in FIG. 4, the SNMP agent 400 can comprise an interface 401, a memory 402 and a processor 403.

The interface 401 can serve as an interface between the SNMP agent 400 and an external network device to transmit packets from the SNMP agent 400 to the external device or receive packets from the external device. In one example, the SNMP agent 400 is an NE device functioning as the SNMP agent, and the external device is a network management server functioning as an SNMP client.

The memory 402 can store data received from the outside, data required for the operations of the apparatus 400, and/or data resulting from the operations of the apparatus 400. In one example, the memory 402 can cache the requests for SNMP Set operation received from the SNMP client, as described below.

The processor 403 can be configured to perform methodologies described above. More specifically, the processor 403 is configured to receive, from the SNMP client, one or more requests for SNMP Set operation; cache the one or more requests in the memory 402; and upon a determined time period being reached, process the cached one or more requests. The processor 403 can comprise any suitable device capable of performing desired processing. For example, the processor 403 can be a general central processing unit (CPU), an application specific integrated circuit (ASIC), a digital signal processor (DSP) or a field programmable gate array (FPGA).

FIG. 5 is a block diagram showing an SNMP client according to an embodiment of the disclosure.

As shown in FIG. 5, the SNMP client 500 can comprise an interface 501, a memory 502 and a processor 503.

The interface 501 can serve as an interface between the SNMP client 500 and an external device to transmit packets from the SNMP client 500 to the external device or receive packets from the external device. In one example, the SNMP client 500 is a network management server functioning as the SNMP client and the external device is an NE device in the network functioning as the SNMP agent.

The memory 502 can store data received from the outside, data required for operations of the SNMP client 500, and/or data resulting from the operations of the apparatus SNMP client 500.

The processor 503 can be configured to perform methodologies described above. More specifically, the processor 503 is configured to transmit, to the SNMP agent, a request for SNMP Set operation; and upon receipt of a response from the SNMP agent indicating the receipt of the request, transmit another request for SNMP Set operation to the SNMP agent. The processor 503 can comprise any suitable device capable of performing desired processing. For example, the processor 503 can be a general central processing unit (CPU), an application specific integrated circuit (ASIC), a digital signal processor (DSP) or a field programmable gate array (FPGA).

It is to be further understood that, because some of the constituent system components and method steps depicted in the accompanying figures are preferably implemented in software program, the actual connections between the system components (or the process steps) may differ depending upon the manner in which the present disclosure is programmed. Given the teachings herein, one of ordinary skill in the related art will be able to contemplate these and similar implementations or configurations of the present disclosure.

1. A method for communication between a first network device and second network device, comprising, at the level of the first network device,
receiving, from the second network device, one or more requests for SNMP (Simple Network Management Protocol) Set operation;
caching the one or more requests; and
upon a determined time period being reached, processing the cached one or more requests.

2. Method according to claim 1, further comprising:
sending a response to the second network device upon receipt of the request.

3. Method according to claim 1, wherein the determined time period is set to start from a time when the first one of the one or more requests is cached.

4. Method according to claim 1, wherein the processing comprises sending the cached one or more requests to a processing device for processing the requests.

5. Method according to claim 1, further comprising:
sending a message to the second network device indicating the status of the processing of the one or more cached requests.

6. A method for communication between a first network device and second network device, comprising, at the level of the second network device
transmitting, to the first network device, a request for SNMP (Simple Network Management Protocol) Set operation; and
upon receipt of a response from the first network device indicating the receipt of the request, transmitting another request for SNMP Set operation to the first network device.

7. Method according to claim 6, further comprising
receiving, from the first network device, a message indicating the status of the processing of the request.

8. An apparatus, comprising:
an interface configured to exchange packets with an external device;
a memory configured to store data required for operation of the apparatus; and
a processor configured to:
receive, from the external device, one or more requests for SNMP (Simple Network Management Protocol) Set operation;
cache the one or more requests in the memory; and
upon a determined time period being reached, process the cached one or more requests.

9. Apparatus according to claim 8, wherein the apparatus is a network device functioning as an SNMP agent.

10. An apparatus, comprising:
an interface configured to exchange packets with an external device;
a memory configured to store data required for operation of the apparatus; and
a processor configured to:
transmit, to the external device, a request for SNMP (Simple Network Management Protocol) Set operation; and
upon receipt of a response from the external device indicating the receipt of the request, transmit another request for SNMP Set operation to the external device.

11. Apparatus according to claim 10, wherein the apparatus is a server functioning as an SNMP agent.
